(19) United States
(12) Patent Application Publication
(10) Pub. No.: US 2025/0006938 A1
(43) Pub. Date: Jan. 2, 2025

(54) SECONDARY BATTERY

(71) Applicant: MURATA MANUFACTURING CO., LTD., Kyoto (JP)

(72) Inventor: Gerile NAREN, Kyoto (JP)

(21) Appl. No.: 18/746,433

(22) Filed: Jun. 18, 2024

(30) Foreign Application Priority Data
Jun. 28, 2023 (JP) 2023-106191

(51) Int. Cl. H01M 4/62; H01M 4/02; H01M 10/0525

(52) U.S. Cl. CPC H01M 4/622; H01M 4/625; H01M 10/0525; H01M 2004/027

(57) ABSTRACT

A secondary battery is provided and includes a positive electrode, a negative electrode, and an electrolytic solution. The negative electrode includes a negative electrode active material layer containing a negative electrode binder and a coating film provided on a surface of the negative electrode active material layer, and the negative electrode binder contains a copolymer of acrylamide, lithium acrylate, and acrylonitrile. A C1s spectrum, an N1s spectrum, and an Li1s spectrum are detected by surface analysis of the negative electrode using X-ray photoelectron spectroscopy, a first concentration ratio as calculated by Equation (1) is 0.4 or more and 2.7 or less, and a second concentration ratio as calculated by Equation (2) is 3.4 or more and 5.9 or less.

### CROSS REFERENCE TO RELATED APPLICATIONS

The present application claims priority to Japanese patent application no. 2023-106191, filed on Jun. 28, 2023, the entire contents of which are incorporated herein by reference.

### BACKGROUND

The present technology relates to a secondary battery.

Since various electronic devices such as mobile phones have been widely used, a secondary battery, which is smaller in size and lighter in weight and allows for a higher energy density, is under development as a power source. The secondary battery includes a positive electrode, a negative electrode, and an electrolytic solution, and various considerations have been given to the configuration of the secondary battery.

For example, an electrode contains a material having an imide bond or an amide bond, and the surface of the electrode is analyzed using X-ray photoelectron spectroscopy.

### SUMMARY

The present technology relates to a secondary battery.

Although various studies have been made to improve battery characteristics of the secondary battery, there is room for improvement because battery characteristics thereof are not yet sufficient.

The present technology, in an embodiment, relates to providing a secondary battery capable of obtaining excellent battery characteristics.

A secondary battery according to an embodiment of the present technology includes a positive electrode, a negative electrode, and an electrolytic solution. The negative electrode includes a negative electrode active material layer containing a negative electrode binder and a coating film provided on a surface of the negative electrode active material layer, and the negative electrode binder contains a copolymer of acrylamide, lithium acrylate, and acrylonitrile. A C1s spectrum, an N1s spectrum, and an Li1s spectrum are detected by surface analysis of the negative electrode using X-ray photoelectron spectroscopy, a first concentration ratio as calculated by Equation (1) is 0.4 or more and 2.7 or less, and a second concentration ratio as calculated by Equation (2) is 3.4 or more and 5.9 or less.

$$X 1 = XC / XN \qquad ( 1 )$$

where X1 is the first concentration ratio, XC is an atomic concentration (atom %) of carbon as calculated based on the C1s spectrum, and XN is an atomic concentration (atom %) of nitrogen as calculated based on the N1s spectrum,

$$X 2 = XL / XN \qquad ( 2 )$$

where X2 is the second concentration ratio, XL is an atomic concentration (atom %) of lithium as calculated based on the Li1s spectrum, and XN is an atomic concentration (atom %) of nitrogen as calculated based on the Nis spectrum.

Here, the C1s spectrum is a spectrum having a peak top within a range in which the binding energy is 282.0 eV to 283.6 eV in the detection result of the C1s spectrum derived from carbon (the horizontal axis represents the binding energy (eV) and the vertical axis represents the spectral intensity (arbitrary unit)).

The N1s spectrum is a spectrum having a peak top within a range in which the binding energy is 394.5 eV to 405.0 eV in the detection result of the N1s spectrum derived from nitrogen (the horizontal axis represents the binding energy (eV) and the vertical axis represents the spectral intensity (arbitrary unit)).

The Li1s spectrum is a spectrum having a peak top within a range in which the binding energy is 50.0 eV to 61.5 eV in the detection result of the Li1s spectrum derived from lithium (the horizontal axis represents the binding energy (eV) and the vertical axis represents the spectral intensity (arbitrary unit)).

Details of an analysis procedure related to surface analysis of the negative electrode using X-ray photoelectron spectroscopy and details of a calculation procedure (including a calculation procedure of each of atomic concentrations XC, XN, and XL) of each of the first concentration ratio and the second concentration ratio will be described later.

According to the secondary battery of an embodiment of the present technology, the negative electrode includes a negative electrode active material layer and a coating film, the negative electrode active material layer contains a negative electrode binder, the negative electrode binder contains a copolymer of acrylamide, lithium acrylate, and acrylonitrile, a first concentration ratio is 0.4 or more and 2.7 or less and a second concentration ratio is 3.4 or more and 5.9 or less in surface analysis of the positive electrode using X-ray photoelectron spectroscopy, so that excellent battery characteristics can be obtained.

The effect of the present technology is not necessarily limited to the effect described here, and may be any effect of a series of effects relating to the present technology including described later according to an embodiment.

### BRIEF DESCRIPTION OF THE FIGURES

FIG. 1 is a sectional view illustrating the configuration of a secondary battery in an embodiment of the present technology;

FIG. 2 is a sectional view illustrating the configuration of a battery element illustrated in FIG. 1; and

FIG. 3 is a plan view illustrating respective configurations of a positive electrode and a negative electrode illustrated in FIG. 2.

### DETAILED DESCRIPTION

The present technology will be described in further detail below including referring to the accompanying drawings according to an embodiment.

First, a secondary battery of an embodiment of the present technology will be described.

The secondary battery described herein is a secondary battery that can obtain a battery capacity by utilizing occlusion and release of an electrode reactant and includes a positive electrode, a negative electrode, and an electrolytic solution.

A charge capacity of the negative electrode is preferably larger than a discharge capacity of the positive electrode. That is, an electrochemical capacity per unit area of the negative electrode is preferably larger than an electrochemical capacity per unit area of the positive electrode. This is to prevent the electrode reactant from precipitating on the surface of the negative electrode during charging.

The type of the electrode reactant is not particularly limited, but is specifically a light metal such as an alkali metal or an alkaline earth metal. Specific examples of the alkali metal include lithium, sodium, and potassium, and specific examples of the alkaline earth metal include beryllium, magnesium, and calcium.

In the following, a description is given of an example case where the electrode reactant is lithium. A secondary battery in which the battery capacity is attained by utilizing occlusion and release of lithium is a so-called lithium ion secondary battery. In the lithium ion secondary battery, lithium is occluded and released in an ionic state.

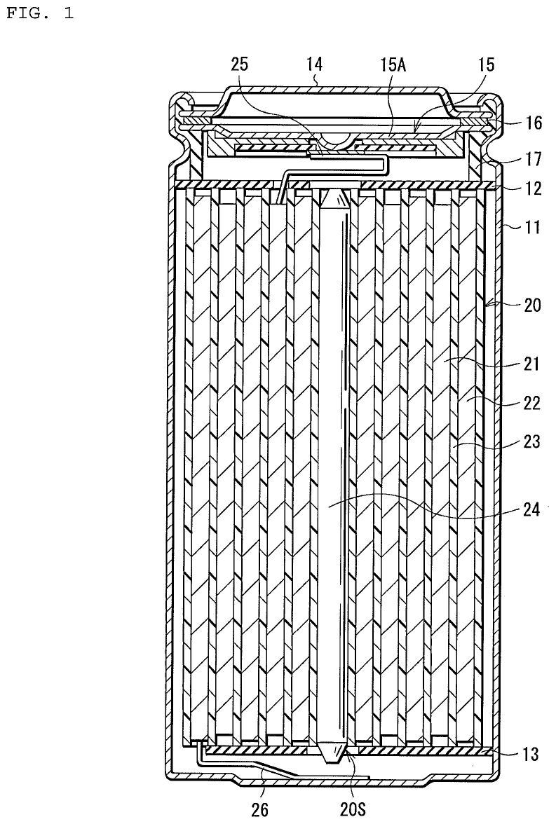

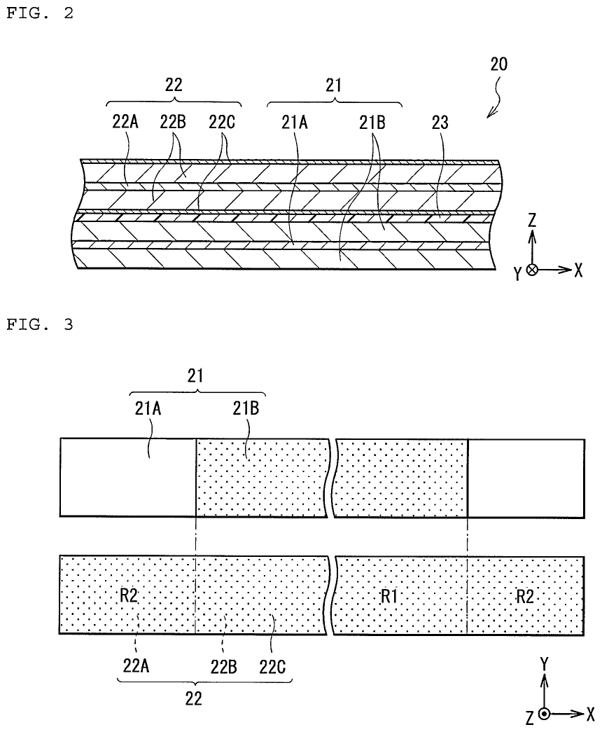

FIG. 1 illustrates a sectional configuration of a secondary battery. FIG. 2 illustrates a sectional configuration of a battery element 20 illustrated in FIG. 1. FIG. 3 illustrates a plan configuration of each of a positive electrode 21 and a negative electrode 22 illustrated in FIG. 2.

It should be understood that FIG. 2 illustrates only a part of the battery element 20. FIG. 3 illustrates a state where each of the positive electrode 21 and the negative electrode 22 is not wound.

As illustrated in FIGS. 1 and 2, the secondary battery mainly includes a battery can 11, a pair of insulating plates 12 and 13, a battery element 20, a positive electrode lead 25, and a negative electrode lead 26.

The secondary battery described herein is a so-called cylindrical secondary battery because the battery element 20 is housed in the battery can 11 having a cylindrical shape.

As illustrated in FIG. 1, the battery can 11 is a housing member that houses the battery element 20 and the like. Since the battery can 11 has one open end portion and the other closed end portion, the battery can 11 has a hollow structure.

The battery can 11 contains any one kind or two or more kinds of metal materials such as iron, aluminum, an iron alloy, and an aluminum alloy. A metal material such as nickel may be plated on the surface of the battery can 11.

A battery cover 14, a safety valve mechanism 15, and a PTC element 16, which is a heat sensitive resistance element, are crimped to one open end portion of the battery can 11 with a gasket 17 interposed therebetween. The battery can 11 is thereby sealed by the battery cover 14. Here, the battery cover 14 contains the same material as the material for forming the battery can 11. Each of the safety valve mechanism 15 and the PTC element 16 is provided inside the battery cover 14, and the safety valve mechanism 15 is electrically connected to the battery cover 14 with the PTC element 16 interposed therebetween. The gasket 17 contains an insulating material, and asphalt or the like may be applied to the surface of the gasket 17.

In the safety valve mechanism 15, when the internal pressure of the battery can 11 reaches a certain level or more due to an internal short circuit, external heating, and the like, a disk plate 15A is reversed, and thus the electrical connection between the battery cover 14 and the battery element 20 is disconnected. In order to prevent abnormal heat generation due to a large current, the electrical resistance of the PTC element 16 rises as the temperature rises.

As illustrated in FIG. 1, the insulating plates 12 and 13 are arranged in such a manner of facing each other with the battery element 20 interposed therebetween. Thus, the battery element 20 is sandwiched between the insulating plates 12 and 13.

The battery element 20 is housed in the battery can 11. The battery element 20 is a so-called power generating element, and includes the positive electrode 21, the negative electrode 22, a separator 23, and an electrolytic solution (not illustrated) as illustrated in FIGS. 1 and 2.

Here, the battery element 20 is a so-called wound electrode body. That is, the positive electrode 21 and the negative electrode 22 are stacked with the separator 23 interposed therebetween, and are wound while facing each other with the separator 23 interposed therebetween. A center pin 24 is inserted into a space 20S provided at the winding center of the battery element 20. It should be understood that the center pin 24 may be omitted.

As illustrated in FIG. 2, the positive electrode 21 includes a positive electrode current collector 21A and a positive electrode active material layer 21B.

The positive electrode current collector 21A has a pair of surfaces on which the positive electrode active material layer 21B is provided. The positive electrode current collector 21A contains a conductive material such as a metal material, and specific examples of the conductive material include aluminum.

The positive electrode active material layer 21B contains any one kind or two or more kinds of positive electrode active materials occluding and releasing lithium. However, the positive electrode active material layer 21B may further contain any one kind or two or more kinds of other materials such as a positive electrode binder and a positive electrode conductive agent. A method for forming the positive electrode active material layer 21B is not particularly limited, but is specifically a coating method or the like.

Here, the positive electrode active material layer 21B is provided on both surfaces of the positive electrode current collector 21A. However, the positive electrode active material layer 21B may be provided only on one surface of the positive electrode current collector 21A on the side where the positive electrode 21 faces the negative electrode 22.

The type of the positive electrode active material is not particularly limited, and is specifically a lithium-containing compound or the like. This is because a high voltage can be obtained. The lithium-containing compound is a compound containing lithium and one kind or two or more kinds of transition metal elements as constituent elements, and may contain one kind or two or more kinds of other elements (excluding lithium and the transition metal elements) as constituent elements. The type of other elements is not particularly limited, but specifically, the other elements are elements belonging to any of Groups 2 to 15 of the long periodic table. The type of the lithium-containing compound is not particularly limited, and specific examples thereof include an oxide, a phosphoric acid compound, a silicic acid compound, and a boric acid compound.

Specific examples of the oxide include LiNiO₂, LiCoO₂, LiCo_{0.98}Al_{0.01}Mg_{0.01}O₂, LiNi_{0.82}Co_{0.14}Al_{0.04}O₂, LiNi_{0.5}Co_{0.2}Mn_{0.3}O₂, and LiMn₂O₄. Specific examples of the phosphoric acid compound include LiFePO₄, LiMnPO₄, and LiFe_{0.5}Mn_{0.5}PO₄.

The positive electrode binder contains any one kind or two or more kinds of materials such as synthetic rubber and a polymer compound. Specific examples of the synthetic rubber include styrene-butadiene rubber, fluorine rubber, and ethylene propylene diene. Specific examples of the polymer compound include polyvinylidene fluoride, polyimide, and carboxymethyl cellulose.

The positive electrode conductive agent contains any one kind or two or more kinds of conductive materials such as a carbon material, a metal material, and a conductive polymer compound, and specific examples of the carbon material include graphite, carbon black, acetylene black, and Ketjen black.

Here, as illustrated in FIG. 3, the positive electrode active material layer 21B is provided on a part of the surface of the positive electrode current collector 21A, and more specifically, is provided in a central region in the longitudinal direction (left-right direction in FIG. 3) of the positive electrode current collector 21A. In FIG. 3, the positive electrode active material layer 21B is shaded.

As illustrated in FIG. 2, the negative electrode 22 includes a negative electrode current collector 22A, a negative electrode active material layer 22B, and a coating film 22C.

The negative electrode current collector 22A has a pair of surfaces on which the negative electrode active material layer 22B is provided. The negative electrode current collector 22A contains a conductive material such as a metal material, and specific examples of the conductive material include copper.

The negative electrode active material layer 22B contains a negative electrode active material and a negative electrode binder. However, the negative electrode active material layer 22B may further include any one kind or two or more kinds of other materials such as a negative electrode conductive agent. A method for forming the negative electrode active material layer 22B is not particularly limited, but is specifically a coating method or the like.

Here, the negative electrode active material layer 22B is provided on both surfaces of the negative electrode current collector 22A. However, the negative electrode active material layer 22B may be provided only on one surface of the negative electrode current collector 22A on the side where the negative electrode 22 faces the positive electrode 21.

The negative electrode active material is a substance occluding and releasing lithium ions. The type of the negative electrode active material is not particularly limited, but is specifically any one kind or two or more kinds of materials such as a carbon material and a metal-based material. This is because a high energy density can be obtained.

Specific examples of the carbon materials include graphitizable carbon, non-graphitizable carbon, and graphite. The graphite may be natural graphite or artificial graphite, or may be both of natural graphite and artificial graphite.

The metal-based material is a generic term for materials containing any one kind or two or more kinds of metal elements and metalloid elements capable of forming an alloy with lithium as constituent elements, and specific examples of the metal elements and metalloid elements are silicon, tin, and the like. The metal-based material may be a simple substance, an alloy, a compound, a mixture of two or more kinds thereof, or a material including two or more phases thereof. Specific examples of the metal-based material include TiSi₂ and SiOₓ (0<x≤2 or 0.2<x<1.4).

A part or all of the surface of the metal-based material may be coated with a carbon material. The details of the carbon material are as described above.

The negative electrode binder is a substance that binds substances such as a negative electrode active material to each other, and contains a ternary copolymer which is a polymer compound.

This ternary copolymer is a copolymer containing three kinds of elements of nitrogen (N), carbon (C), and lithium (Li) as constituent elements, and more specifically, a copolymer of acrylamide, lithium acrylate, and acrylonitrile.

Since acrylamide contains a nitrogen-containing group (—C(═O)—NH₂), carbon and nitrogen are contained as constituent elements. Since lithium acrylate contains a lithium-containing group (—C(═O)—OLi), carbon and lithium are contained as constituent elements. Since acrylonitrile contains a nitrogen-containing group (—CN), carbon and nitrogen are contained as constituent elements. Thus, the ternary copolymer contains carbon, nitrogen, and lithium as constituent elements.

The copolymerization amounts of acrylamide, lithium acrylate, and acrylonitrile in the ternary copolymer are not particularly limited, and can be arbitrarily set.

The reason why the negative electrode binder contains the ternary copolymer is that, as described later, the negative electrode binder is decomposed, reacted, and eluted in a manufacturing process of the secondary battery (stabilization treatment of the assembled secondary battery), so that the coating film 22C containing carbon, nitrogen, and lithium as constituent elements is formed. Thus, the negative electrode binder containing the ternary copolymer is a supply source of carbon, nitrogen, and lithium contained as constituent elements in the coating film 22C.

The ternary copolymer may further contain a copolymer of acrylamide, acrylic acid, and acrylonitrile, a copolymer of acrylamide, acrylic acid, lithium acrylate, and acrylonitrile, or both the copolymers. Since this acrylic acid contains a carboxyl group (—C(═O)—OH), carbon is contained as a constituent element, but lithium is not contained as a constituent element.

The copolymerization amount of acrylic acid in the ternary copolymer is not particularly limited. In particular, the copolymerization amount of acrylic acid in the ternary copolymer is preferably sufficiently smaller than the copolymerization amount of each of acrylamide, lithium acrylate, and acrylonitrile in the ternary copolymer. This is because the supply amount of lithium contained as a constituent element in the coating film 22C is secured.

The negative electrode binder may further contain any one kind or two or more kinds of other polymer compounds (excluding the ternary copolymer) as necessary. The positive electrode binder contains any one kind or two or more kinds of synthetic rubber, a polymer compound, and the like. The details of each of the synthetic rubber and the polymer compound are as described above.

The negative electrode conductive agent is a substance that improves the conductivity of the negative electrode active material layer 22B, and the details of the negative electrode conductive agent are the same as the details of the positive electrode conductive agent.

Among others, it is preferable that the negative electrode conductive agent contains a carbon material. This is because the carbon material not only functions as a negative electrode conductive agent but also functions as a negative electrode active material, and thus the conductivity of the negative electrode active material layer 22B is improved, and the occlusion and release properties of lithium in the negative electrode active material layer 22B are also improved.

Since the coating film 22C is provided on the surface of the negative electrode active material layer 22B, the coating film 22C covers the surface of the negative electrode active material layer 22B.

Here, the coating film 22C covers the entire surface of the negative electrode active material layer 22B. However, the coating film 22C may cover only a part of the surface of the negative electrode active material layer 22B. In this case, a plurality of coating films 22C separated from each other may cover the surface of the negative electrode active material layer 22B.

As described above, the coating film 22C is formed on the surface of the negative electrode active material layer 22B using the stabilization treatment of the assembled secondary battery, and contains, as constituent elements, carbon, nitrogen, and lithium derived from a ternary copolymer as a negative electrode binder. The composition of the coating film 22C is not particularly limited as long as it contains carbon, nitrogen, and lithium as constituent elements.

The thickness of the coating film 22C is not particularly limited, and thus can be arbitrarily set. In particular, the thickness of the coating film 22C is preferably sufficiently small, and more specifically, is preferably 10 nm or less. This is because, since the thickness of the coating film 22C is not too large, an excessive increase in the internal resistance of the negative electrode 22 is suppressed, and also an excessive decrease in the occlusion and release properties of lithium in the negative electrode active material layer 22B is suppressed.

Here, as illustrated in FIG. 3, the negative electrode active material layer 22B is provided on the entire surface of the negative electrode current collector 22A, and more specifically, is provided in the entire region in the longitudinal direction (left-right direction in FIG. 3) of the negative electrode current collector 22A. As a result, the coating film 22C is provided in the entire region in the longitudinal direction of the negative electrode current collector 22A, similarly to the negative electrode active material layer 22B. In FIG. 3, the coating film 22C is shaded.

Therefore, the negative electrode 22 includes one opposed portion R1 and two non-opposed portions R2. The opposed portion R1 is a portion involved in the charge-discharge reaction since the negative electrode active material layer 22B faces the positive electrode active material layer 21B. On the other hand, the non-opposed portion R2 is a portion not substantially involved in the charge-discharge reaction since the negative electrode active material layer 22B does not face the positive electrode active material layer 21B. Here, the opposed portion R1 is disposed between the two non-opposed portions R2.

In the secondary battery, in order to improve battery characteristics, a predetermined condition is satisfied with respect to physical properties of the negative electrode 22 (coating film 22C). Details of the physical properties of the negative electrode 22 will be described later.

As illustrated in FIG. 2, the separator 23 is an insulating porous film interposed between the positive electrode 21 and the negative electrode 22, and allows lithium to pass therethrough in an ionic state while preventing occurrence of a short circuit resulting from contact of the positive electrode 21 and the negative electrode 22. The separator 23 contains a polymer compound such as polyethylene.

The electrolytic solution is a liquid electrolyte and is impregnated in each of the positive electrode 21, the negative electrode 22, and the separator 23. This electrolytic solution contains a solvent and an electrolyte salt.

The solvent contains any one kind or two or more kinds of non-aqueous solvents (organic solvents), and the electrolytic solution containing the non-aqueous solvent is a so-called non-aqueous electrolytic solution.

The non-aqueous solvent is an ester, an ether, or the like, and more specifically, is a carbonic acid ester-based compound, a carboxylic acid ester-based compound, and a lactone-based compound, or the like. This is because a dissociative nature of the electrolyte salt and mobility of the ions are improved.

The carbonic acid ester-based compound is a cyclic carbonic acid ester and a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic acid ester-based compound is a chain carboxylic acid ester or the like. Specific examples of the chain carboxylic acid ester include ethyl acetate, ethyl propionate, propyl propionate, and ethyl trimethylacetate.

The lactone-based compound is a lactone or the like. Specific examples of the lactone include γ-butyrolactone and γ-valerolactone.

The ethers may be 1,2-dimethoxyethane, tetrahydrofuran, 1,3-dioxolane, 1,4-dioxane, or the like.

The non-aqueous solvent is an unsaturated cyclic carbonic acid ester, a fluorinated cyclic carbonic acid ester, a sulfonic acid ester, a phosphoric acid ester, an acid anhydride, a nitrile compound, an isocyanate compound, and the like. This is because electrochemical stability of the electrolytic solution is improved.

Specific examples of the unsaturated cyclic carbonic acid ester include vinylene carbonate, vinyl ethylene carbonate, and methylene ethylene carbonate. Specific examples of the fluorinated cyclic carbonic acid ester include ethylene monofluorocarbonate and ethylene difluorocarbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

The electrolyte salt contains any one kind or two or more kinds of light metal salts such as lithium salts.

Specific examples of the lithium salt include lithium hexafluorophosphate (LiPE₆), lithium tetrafluoroborate (LiBE₄), lithium trifluoromethanesulfonate (LiCF₃SO₃), lithium bis(fluorosulfonyl)imide (LiN(FSO₂)₂), lithium bis(trifluoromethanesulfonyl)imide (LIN (CF₃SO₂)₂), lithium tris(trifluoromethanesulfonyl)methide (LiC(CF₃SO₂)₃), lithium bis(oxalato) borate (LiB(C₂O₄)₂), lithium monofluorophosphate (Li₂PFO₃), and lithium difluorophosphate (LiPF₂O₂). This is because a high battery capacity can be obtained.

The content of the electrolyte salt is not particularly limited, and is specifically 0.3 mol/kg to 3.0 mol/kg inclusive with respect to the solvent. This is because high ion conductivity can be obtained.

As illustrated in FIGS. 1 and 2, the positive electrode lead 25 is connected to the positive electrode current collector 21A of the positive electrode 21 and contains a conductive material such as aluminum. The positive electrode lead 25 is electrically connected to the battery cover 14 with the safety valve mechanism 15 interposed therebetween.

As illustrated in FIGS. 1 and 2, the negative electrode lead 26 is connected to the negative electrode current collector 22A of the negative electrode 22 and contains a conductive material such as nickel. The negative electrode lead 26 is electrically connected to the battery can 11.

In the secondary battery, as described above, in order to improve battery characteristics, a predetermined condition is satisfied with respect to physical properties of the negative electrode 22.

Specifically, regarding the analysis result of the surface of the negative electrode 22 using X-ray photoelectron spectroscopy (XPS), that is, the analysis result of the coating film 22C existing on the outermost surface of the negative electrode 22, two types of conditions (physical property conditions 1 and 2) described below are satisfied.

As described above, the coating film 22C contains carbon, nitrogen, and lithium as constituent elements. Therefore, by surface analysis of the coating film 22C using XPS, a carbon spectrum (C1s spectrum), a nitrogen spectrum (N1s spectrum), and a lithium spectrum (Li1s spectrum) are detected as three types of XPS spectra.

In the surface analysis of the coating film 22C using XPS, any one kind or two or more kinds of spectra other than the above-described three types of XPS spectra may be further detected. Specific examples of the other spectra include a fluorine spectrum (F1s spectrum), an oxygen spectrum (O1s spectrum), a boron spectrum (B1s spectrum), a phosphorus spectrum (P2p spectrum), and a silicon spectrum (Si2p spectrum).

In the surface analysis, all the atoms contained in the coating film 22C are analyzed in a region between the position of the surface of the coating film 22C and the position of a depth of 10 nm from the surface of the coating film 22C. As a result, as described above, the C1s spectrum, the N1s spectrum, and the Li1s spectrum are detected.

The C1s spectrum is an XPS spectrum derived from carbon (carbon atom) contained in the coating film 22C. The N1s spectrum is an XPS spectrum derived from nitrogen (nitrogen atom) contained in the coating film 22C. The Li1s spectrum is an XPS spectrum derived from lithium (lithium atom) contained in the coating film 22C.

Here, the C1s spectrum is a spectrum having a peak top within a range in which the binding energy is 279.0 eV to 296.5 eV in the detection result of the C1s spectrum derived from carbon (the horizontal axis represents the binding energy (eV) and the vertical axis represents the spectral intensity (arbitrary unit)).

When there are a plurality of peaks in the detection result of the C1s spectrum, as described above, a spectrum having a peak top within a range in which the binding energy is 282.0 eV to 283.6 eV is defined as a C1s spectrum.

The N1s spectrum is a spectrum having a peak top within a range in which the binding energy is 394.0 eV to 408.0 eV in the detection result of the Nis spectrum derived from nitrogen (the horizontal axis represents the binding energy (eV) and the vertical axis represents the spectral intensity (arbitrary unit)).

When there are a plurality of peaks in the detection result of the Nis spectrum, as described above, a spectrum having a peak top within a range in which the binding energy is 394.5 eV to 405.0 eV is defined as an Nis spectrum.

The Li1s spectrum is a spectrum having a peak top within a range in which the binding energy is 50.0 eV to 63.0 eV in the detection result of the Li1s spectrum derived from lithium (the horizontal axis represents the binding energy (eV) and the vertical axis represents the spectral intensity (arbitrary unit)).

When there are a plurality of peaks in the detection result of the Li1s spectrum, a spectrum having a peak top within a range in which the binding energy is 50.0 eV to 61.5 eV is defined as an Li1s spectrum.

Thus, the atomic concentration (atom %) of carbon contained in the coating film 22C is calculated based on the C1s spectrum. The atomic concentration of carbon indicates how many atomic percentage the atomic concentration of carbon corresponds when the sum of the atomic concentrations of all the atoms present within the analysis range in the surface analysis of the coating film 22C using XPS is 100 atom %.

The atomic concentration (atom %) of nitrogen contained in the coating film 22C is calculated based on the N1s spectrum. The atomic concentration of nitrogen indicates how many atomic percentage the atomic concentration of nitrogen corresponds when the sum of the atomic concentrations of all the atoms present within the analysis range in the surface analysis of the coating film 22C using XPS is 100 atom %.

The atomic concentration (atom %) of lithium contained in the coating film 22C is calculated based on the Li1s spectrum. The atomic concentration of lithium indicates how many atomic percentage the atomic concentration of lithium corresponds when the sum of the atomic concentrations of all the atoms present within the analysis range in the surface analysis of the coating film 22C using XPS is 100 atom %.

The concentration ratio X1, which is the first concentration ratio as calculated by Equation (1), is 0.4 to 2.7. The concentration ratio X1 is an index representing the relationship between the atomic concentration XC of carbon and the atomic concentration XN of nitrogen in the vicinity of the surface of the coating film 22C, and represents how much the atomic concentration XC is with respect to the atomic concentration XN. However, each value of the atomic concentrations XC and XN and the concentration ratio X1 is a value obtained by rounding off the value at the second decimal place.

$$X 1 = XC / XN \qquad ( 1 )$$

where X1 is the first concentration ratio, XC is an atomic concentration (atom %) of carbon as calculated based on the C1s spectrum, and XN is an atomic concentration (atom %) of nitrogen as calculated based on the Nis spectrum.

The concentration ratio X1 can be adjusted to be within the above range (X1=0.4 to 2.7) by changing the mixing ratio of the negative electrode active material and the negative electrode binder. When the negative electrode active material layer 22B further contains a negative electrode conductive agent, the concentration ratio X1 can be adjusted to be within the above range (X1=0.4 to 2.7) by changing the mixing ratio of the negative electrode active material, the negative electrode binder, and the negative electrode conductive agent.

The concentration ratio X2, which is the second concentration ratio as calculated by Equation (2), is 3.4 to 5.9. The concentration ratio X2 is an index representing the relationship between the atomic concentration XL of lithium and the atomic concentration XN of nitrogen in the vicinity of the surface of the coating film 22C, and represents how much the atomic concentration XL is with respect to the atomic concentration XC. However, each value of the atomic concentration XL and the concentration ratio X2 is a value obtained by rounding off the value at the second decimal place.

X2=XL/XN (2)

where X2 is the second concentration ratio, XL is an atomic concentration (atom %) of lithium as calculated based on the Li1s spectrum, and XN is an atomic concentration (atom %) of nitrogen as calculated based on the Nis spectrum.

The concentration ratio X2 can be adjusted to be within the above range (X2=3.4 to 5.9) by changing the mixing ratio of the negative electrode active material and the negative electrode binder. When the negative electrode active material layer 22B further contains a negative electrode conductive agent, the concentration ratio X2 can be adjusted to be within the above range (X2=3.4 to 5.9) by changing the mixing ratio of the negative electrode active material, the negative electrode binder, and the negative electrode conductive agent.

The physical property conditions 1 and 2 are satisfied because the physical properties of the coating film 22C are optimized as compared with a case where the physical property conditions 1 and 2 are not satisfied, so that the distribution of each of carbon, nitrogen, and lithium in the vicinity of the surface of the negative electrode 22 is optimized. In this case, the input/output efficiency of lithium in the negative electrode active material layer 22B is improved while an increase in the internal resistance of the coating film 22C is suppressed. As a result, the irreversible capacity due to consumption of lithium during charging and discharging is reduced while the conductivity of the negative electrode 22 is secured, and thus lithium is smoothly and stably occluded and released in the negative electrode 22. In particular, when charging and discharging are repeated, lithium is easily occluded and released smoothly and stably in the negative electrode 22.

The analysis procedure of the negative electrode 22 using XPS and the calculation procedure of each of the concentration ratios X1 and X2 (including a calculation procedure of each of atomic concentrations XC, XN, and XL) are as described below.

First, in order to bring the secondary battery into a discharged state, the secondary battery is discharged until the battery voltage reaches 2.0 V. The current at the time of discharging is not particularly limited, and thus can be arbitrarily set.

Subsequently, the negative electrode 22 is recovered by disassembling the secondary battery. Subsequently, the negative electrode 22 is washed using an organic solvent such as dimethyl carbonate, and then the negative electrode 22 is dried. Subsequently, the negative electrode 22 is cut into a rectangular shape (10 mm×10 mm) to obtain a sample for analysis.

Subsequently, the sample is subjected to surface analysis using an XPS analyzer. In this case, a scanning X-ray photoelectron spectrometer PHI Quantera SXM manufactured by ULVAC-PHI, INCORPORATED. was used as the XPS analyzer. Analysis conditions are as follows: Light source=monochromatic Al Kα beam (1486.6 eV), degree of vacuum=1×10⁻⁹ Torr (=about 133.3×10⁻⁹ Pa), analysis range (diameter)=100 μm, analysis depth=10 nm, and use of an electron flood gun=yes.

As a result, since the surface (coating film 22C) of the negative electrode 22 is analyzed, each of the C1s spectrum, the N1s spectrum, and the Li1s spectrum is detected. Each of the atomic concentrations XC, XN, and XL (atom %) is calculated using the calculation function of the XPS analyzer.

Here, when each of the C1s spectrum, the N1s spectrum, and the Li1s spectrum is detected and each of the atomic concentrations XC, XN, and XL (atom %) is calculated using an XPS analyzer, the treatment described below is performed using the function of the XPS analyzer.

First, when each of the C1s spectrum, the N1s spectrum, and the Li1s spectrum is detected, a so-called peak shift is performed. In this case, the positions of a series of spectra including the C1s spectrum, the N1s spectrum, and the Li1s spectrum are corrected such that the position (binding energy) of the peak top of the spectrum derived from lithium fluoride (Li—F) is 685.1 eV.

Second, when each of the C1s spectrum, the N1s spectrum, and the Li1s spectrum is specified, a so-called peak separation is performed as necessary.

Specifically, when there are a plurality of peaks in the detection result of the C1s spectrum, a spectrum (C1s spectrum) having a peak top within a range in which the binding energy is 282.0 eV to 283.6 eV is separated from the other spectra. As a result, the C1s spectrum used to calculate the atomic concentration XC is specified.

When there are a plurality of peaks in the detection result of the Ns spectrum, a spectrum (N1s spectrum) having a peak top within a range in which the binding energy is 394.5 eV to 405.0 eV is separated from the other spectra. As a result, the N1s spectrum used to calculate the atomic concentration XN is specified.

When there are a plurality of peaks in the detection result of the Li1s spectrum, a spectrum (Li1s spectrum) having a peak top within a range in which the binding energy is 50.0 eV to 61.5 eV is separated from the other spectra. As a result, the Li1s spectrum used to calculate the atomic concentration XL is specified.

Third, when each of the atomic concentrations XC, XN, and XL is calculated, each range (binding energy range) of the C1s spectrum, N1s spectrum, and the Li1s spectrum used for calculating each of the atomic concentrations XC, XN, and XL is set.

Specifically, when the atomic concentration XC is calculated, the range (binding energy range) of the C1s spectrum used for calculating the atomic concentration XC is set to 282.0 eV to 283.6 eV. When the atomic concentration XN is calculated, the range (binding energy range) of the N1s spectrum used for calculating the atomic concentration XN is set to 394.5 eV to 405.0 eV. When the atomic concentration XL is calculated, the range (binding energy range) of the Li1s spectrum used for calculating the atomic concentration XL is set to 50.0 eV to 61.5 eV.

Therefore, the concentration ratio X1 is calculated based on the atomic concentrations XC and XN, and the concentration ratio X2 is calculated based on the atomic concentrations XC and XL.

Finally, the calculation operation of the concentration ratio X1 described above is repeated 20 times, and then the average value of the 20 concentration ratios X1 is calculated to obtain the final concentration ratio X1 (concentration ratio X1 used for determining whether the physical property condition 1 is satisfied).

The calculation operation of the concentration ratio X2 described above is repeated 20 times, and then the average value of the 20 concentration ratios X2 is calculated to obtain the final concentration ratio X2 (concentration ratio X2 used for determining whether the physical property condition 2 is satisfied).

As a result, each of the concentration ratios X1 and X2 is specified based on the surface analysis result of the negative electrode 22 using XPS.

In the case of examining the physical properties of the negative electrode 22, that is, in the case of examining whether or not the physical property conditions 1 and 2 are satisfied, it is preferable to perform surface analysis on the non-opposed portion R2 of the negative electrode 22 as illustrated in FIG. 3. This is because, as described above, since the non-opposed portion R2 is a portion not substantially involved in the charge-discharge reaction, the physical properties of the negative electrode 22 can be accurately examined with high reproducibility without depending on the charge-discharge history (the presence or absence of charge and discharge, the number of times of charge and discharge, and the like).

The secondary battery operates as follows in the battery element 20.

During charging, lithium is released from the positive electrode 21, and the lithium is occluded in the negative electrode 22 with the electrolytic solution interposed therebetween. On the other hand, during discharging, lithium is released from the negative electrode 22, and the lithium is occluded in the positive electrode 21 with the electrolytic solution interposed therebetween. At each of the time of discharge and the time of charge, lithium is occluded and released in an ionic state.

In the case of manufacturing a secondary battery, a secondary battery is assembled using an exemplary procedure described below, and then a stabilization treatment of the assembled secondary battery is performed.

First, a positive electrode active material, a positive electrode binder, and a positive electrode conductive agent are mixed together to obtain a positive electrode mixture. Subsequently, the positive electrode mixture is put into a solvent to prepare a positive electrode mixture slurry in the form of paste. The solvent may be an aqueous solvent or an organic solvent. Subsequently, the positive electrode mixture slurry is applied to both sides of the positive electrode current collector 21A to form the positive electrode active material layer 21B. Finally, the positive electrode active material layer 21B is compression-molded using a molding device such as a roll press machine. In this case, the positive electrode active material layer 21B may be heated, or compression molding may be repeated plural times. As a result, the positive electrode 21 including the positive electrode current collector 21A and the positive electrode active material layer 21B is produced.

First, a negative electrode active material, a negative electrode binder containing a ternary copolymer, and a negative electrode conductive agent are mixed together to obtain a negative electrode mixture. Subsequently, the negative electrode mixture is put into a solvent to prepare a negative electrode mixture slurry in the form of paste. The details of the solvent are as described above.

Subsequently, the negative electrode mixture slurry is applied to both sides of the negative electrode current collector 22A to form the negative electrode active material layer 22B. Subsequently, the negative electrode active material layer 22B is compression-molded using a molding device such as a roll press machine. The details of the compression molding are as described above.

Finally, after the secondary battery is assembled, a stabilization treatment is performed using the assembled secondary battery. As a result, the coating film 22C is formed on the surface of the negative electrode active material layer 22B, thereby producing the negative electrode 22 including the negative electrode current collector 22A, the negative electrode active material layer 22B, and the coating film 22C.

The electrolyte salt is put into the solvent. As a result, the electrolyte salt is dispersed or dissolved in the solvent, thereby preparing an electrolytic solution.

First, the positive electrode lead 25 is connected to the positive electrode current collector 21A of the positive electrode 21 by a joining method such as a welding method, and the negative electrode lead 26 is connected to the negative electrode current collector 22A of the negative electrode 22 by a joining method such as a welding method.

Subsequently, the positive electrode 21 and the negative electrode current collector 22A on which the negative electrode active material layer 22B is formed are laminated on each other with the separator 23 interposed therebetween, thereby forming a laminate (not illustrated). Subsequently, the laminate is wound to produce a wound body (not illustrated) having the space 20S. The wound body has the same configuration as the configuration of the battery element 20, except that the wound body does not include the coating film 22C and is not impregnated with the electrolytic solution.

Subsequently, the wound body and the insulating plates 12 and 13 are housed in the battery can 11 in a state where the wound body is sandwiched between the insulating plates 12 and 13. In this case, the positive electrode lead 25 is connected to the safety valve mechanism 15 by a joining method such as a welding method, and the negative electrode lead 26 is connected to the battery can 11 by a joining method such as a welding method. Then, the wound body is impregnated with the electrolytic solution by injecting the electrolytic solution into the battery can 11.

Finally, the battery cover 14, the safety valve mechanism 15, and the PTC element 16 are accommodated inside the battery can 11, and then the battery can 11 is crimped with the gasket 17 interposed therebetween.

As a result, the battery cover 14, the safety valve mechanism 15, and the PTC element 16 are fixed to the battery can 11, and the wound body is enclosed in the battery can 11, so that the secondary battery is assembled.

The assembled secondary battery is charged and discharged. Stabilization conditions such as an environmental temperature, the number of times of charge and discharge (the number of cycles), and charge and discharge conditions can be arbitrarily set.

As a result, the coating film 22C is formed on the surface of the negative electrode active material layer 22B, thereby producing the negative electrode 22. In this case, a coating film having the same configuration as the configuration of the coating film 22C may be formed on the surface of the positive electrode active material layer 21B. Therefore, the battery element 20 is produced, and the battery element 20 is enclosed in the battery can 11, so that the secondary battery is completed.

According to the secondary battery, the negative electrode 22 includes the negative electrode active material layer 22B and the coating film 22C, and the negative electrode active material layer 22B contains a negative electrode binder (ternary copolymer). In surface analysis of the negative electrode 22 using XPS, the concentration ratio X1 is 0.4 to 2.7, and the concentration ratio X2 is 3.4 to 5.9.

In this case, as described above, since the coating film 22C is formed using a ternary copolymer, the coating film 22C containing carbon, nitrogen, and lithium derived from the ternary copolymer as constituent elements is formed. As described above, since the physical properties of the coating film 22C are optimized by satisfying the physical property conditions 1 and 2, the distribution of each of carbon, nitrogen, and lithium in the vicinity of the surface of the negative electrode 22 is optimized. As a result, the input/output efficiency of lithium in the negative electrode active material layer 22B is improved while an increase in the internal resistance of the coating film 22C is suppressed.

From these, the irreversible capacity due to consumption of lithium during charging and discharging is reduced while the conductivity of the negative electrode 22 is secured, and thus lithium is smoothly and stably occluded and released in the negative electrode 22 when charging and discharging are repeated. Accordingly, excellent battery characteristics can be obtained.

In particular, when the negative electrode active material layer 22B contains a negative electrode conductive agent and the negative electrode conductive agent contains a carbon material, not only the conductivity of the negative electrode active material layer 22B is improved, but also the occlusion and release properties of lithium in the negative electrode active material layer 22B are improved, so that a higher effect can be obtained.

When the secondary battery is a lithium ion secondary battery, a sufficient battery capacity can be stably obtained using occlusion and release of lithium, so that a higher effect can be obtained.

The configuration of the secondary battery can be appropriately changed including as described below according to an embodiment. However, some of modification examples described below may be combined with each other.

The separator 23 which is a porous film was used. However, although not specifically illustrated in the drawings, a laminated type separator including a polymer compound layer may be used instead of the separator 23 which is a porous film.

Specifically, the laminated type separator includes a porous film having a pair of surfaces and a polymer compound layer provided on one surface or both surfaces of the porous film. This is because the adhesive property of the separator to each of the positive electrode 21 and the negative electrode 22 is improved, so that positional displacement of the battery element 20 is suppressed. As a result, since the winding deviation of each of the positive electrode 21, the negative electrode 22, and the separator is suppressed, the swelling of the secondary battery is suppressed when the decomposition reaction of the electrolytic solution occurs. The polymer compound layer contains polyvinylidene fluoride or the like. This is because polyvinylidene fluoride is excellent in physical strength, and electrochemically stable.

One or both of the porous film and the polymer compound layer may contain any one kind or two or more kinds of a plurality of insulating particles. This is because the plurality of insulating particles dissipate heat at the time of heat generation of the secondary battery, thereby improving the safety (heat resistance) of the secondary battery. The plurality of insulating particles contain any one kind or two or more kinds of insulating materials such as an inorganic material and a resin material. Specific examples of the inorganic material include aluminum oxide, aluminum nitride, boehmite, silicon oxide, titanium oxide, magnesium oxide, and zirconium oxide. Specific examples of the resin material include an acrylic resin and a styrene resin.

In the case of producing a laminated type separator, a precursor solution containing a polymer compound, an organic solvent, and the like is prepared, and then the precursor solution is applied to one surface or both surfaces of the porous film. In this case, a plurality of insulating particles may be contained in the precursor solution.

Also in the case of using the laminated type separator, lithium can move in an ionic state between the positive electrode 21 and the negative electrode 22, so that the same effect can be obtained. In this case, in particular, as described above, the swelling of the secondary battery is further suppressed, so that a higher effect can be obtained.

An electrolytic solution which was a liquid electrolyte was used. However, although not specifically illustrated in the drawing, an electrolyte layer that is a gel-like electrolyte may be used.

In the battery element 20 using the electrolyte layer, the positive electrode 21 and the negative electrode 22 are wound while facing each other with the separator 23 and the electrolyte layer interposed therebetween. The electrolyte layer is interposed between the positive electrode 21 and the separator 23, and is interposed between the negative electrode 22 and the separator 23.

Specifically, the electrolyte layer contains an electrolytic solution and a polymer compound, and the electrolytic solution is held by the polymer compound. This is because leakage of the electrolytic solution is prevented. The configuration of the electrolytic solution is as described above. The polymer compound contains polyvinylidene fluoride or the like. In the case of forming an electrolyte layer, a precursor solution containing an electrolytic solution, a polymer compound, a solvent, and the like is prepared, and then the precursor solution is applied to one surface or both surfaces of each of the positive electrode 21 and the negative electrode 22.

Also in the case of using the electrolyte layer, lithium ions can move between the positive electrode 21 and the negative electrode 22 with the electrolyte layer interposed therebetween, so that the same effect can be obtained. In this case, in particular, as described above, leakage of the electrolytic solution is prevented, so that a higher effect can be obtained.

A description is given on applications (application examples) of the secondary battery according to an embodiment.

The application of the secondary battery is not particularly limited. The secondary battery to be used as a power source may be a main power source or an auxiliary power source in electronic devices, electric vehicles, and the like. The main power source is a power supply that is preferentially used regardless of the presence or absence of another power source. The auxiliary power source may be a power source which is used instead of the main power supply, or a power source which is switched from the main power source.

Specific examples of the application of the secondary battery are as described below. The secondary battery can be applied to electronic devices such as a video camcorder, a digital still camera, a mobile phone, a notebook personal computer, a headphone stereo, a portable radio, and a portable information terminal. The secondary battery can be applied to storage devices such as backup power sources and memory cards. The secondary battery can be applied to power tools such as electric drills and electric saws. The secondary battery can be applied to a battery pack mounted on an electronic device or the like. The secondary battery can be applied to medical electronic devices such as pacemakers and hearing aids. The secondary battery can be applied to electric vehicles such as electric cars (including hybrid cars). The secondary battery can be applied to power storage systems such as domestic or industrial battery systems that store electric power in preparation for emergency or the like. In these applications, one secondary battery may be used, or a plurality of secondary batteries may be used.

The battery pack may include a single battery or an assembled battery. The electric vehicle is a vehicle which travels using the secondary battery as a power source for driving, and may be a hybrid automobile including a driving source in addition to the secondary battery. In a home electric power storage system, home electric products and the like can be used using electric power accumulated in the secondary battery as an electric power storage source.

### EXAMPLES

Description is given on examples of the present technology according to an embodiment.

### Examples 1 to 3 and Comparative Examples 1 to 6

As described below, after a secondary battery was manufactured, battery characteristics of the secondary battery were evaluated.

### [Production of Secondary Battery]

A cylindrical lithium ion secondary battery illustrated in FIGS. 1 to 3 was produced by the following procedure.

### (Production of Positive Electrode)

First, a positive electrode mixture was prepared by mixing 95.9 parts by mass of LiNi_{0.82}Co_{0.14}Al_{0.04}O₂), which is a positive electrode active material (lithium-containing compound (oxide)), 1.5 parts by mass of a positive electrode binder (polyvinylidene fluoride), 2.5 parts by mass of a positive electrode conductive agent (carbon black), and 0.1 parts by mass of an additive (polyvinylpyrrolidone) together. Subsequently, the positive electrode mixture was put into a solvent (N-methyl-2-pyrrolidone as an organic solvent), and then the organic solvent was stirred to prepare a paste-like positive electrode mixture slurry. Next, the positive electrode mixture slurry was applied to both sides of the positive electrode current collector 21A (strip-shaped aluminum foil having a thickness of 15 μm) using a coating apparatus, and then the positive electrode mixture slurry was dried to form the positive electrode active material layer 21B. Finally, the positive electrode active material layer 21B was compression-molded using a roll press machine. Thereby, the positive electrode 21 was produced.

### (Production of Negative Electrode)

First, a negative electrode mixture was prepared by mixing a negative electrode active material, a negative electrode binder (ternary copolymer), and a negative electrode conductive agent (carbon black as a carbon material) together.

As the negative electrode active material, a mixture of graphite as a carbon material and silicon oxide (SiO) as a metal-based material was used. However, as the metal-based material, silicon oxide whose surface was coated with a carbon material (graphite) was used.

As the ternary copolymer, a copolymer (AAALi) of acrylamide, lithium acrylate, and acrylonitrile was used. In this case, the copolymerization amounts of acrylamide, lithium acrylate, and acrylonitrile were set to 18.6 wt %, 36.2 wt %, and 45.2 wt %, respectively.

In this case, as described later, in order to change each of the concentration ratios X1 and X2, the mixing ratio (mass ratio) of the negative electrode active material, the negative electrode binder, and the negative electrode conductive agent was adjusted. Specifically, the mixing ratio of negative electrode active material was adjusted within a range of 95.0 parts by mass to 97.5 parts by mass, the mixing ratio of the negative electrode binder was adjusted within a range of 1.7 parts by mass to 3.8 parts by mass, and the mixing ratio of the negative electrode conductive agent was adjusted within a range of 0.8 parts by mass to 1.2 parts by mass.

The mixing ratio (mass ratio) of the carbon material and the metal-based material with respect to the negative electrode active material was set to the carbon material: the metal-based material=14.4:1.

Subsequently, the negative electrode mixture was put into a solvent (N-methyl-2-pyrrolidone as an organic solvent), and then the organic solvent was stirred to prepare a paste-like negative electrode mixture slurry. Subsequently, the negative electrode mixture slurry was applied to both surfaces of the negative electrode current collector 22A (strip-shaped copper foil having a thickness of 15 μm) using a coating apparatus and then dried to form the negative electrode active material layer 22B. Subsequently, the negative electrode active material layer 22B was compression-molded using a roll press machine.

Finally, as described later, after the secondary battery was assembled, a stabilization treatment was performed using the assembled secondary battery. As a result, the coating film 22C was formed on the surface of the negative electrode active material layer 22B, thereby producing the negative electrode 22.

### (Preparation of Electrolytic Solution)

Electrolyte salts (lithium hexafluorophosphate and lithium tetrafluoroborate) were put into a solvent (ethylene carbonate which is cyclic carbonic acid ester and diethyl carbonate which is a chain carbonic acid ester), and the solvent was stirred. Thereby, the electrolytic solution was prepared.

In this case, the mixing ratio (weight ratio) of the solvent was set to ethylene carbonate:diethyl carbonate=13:59. By setting the content of lithium hexafluorophosphate in the electrolytic solution to 18.5 wt % and the content of lithium tetrafluoroborate in the electrolytic solution to 0.7 wt %, the content of the electrolyte salts in the electrolytic solution was set to 19.2 wt %.

### (Assembly of Secondary Battery)

First, the positive electrode lead 25 (aluminum foil) was welded to the positive electrode current collector 21A of the positive electrode 21, and the negative electrode lead 26 (copper foil) was welded to the negative electrode current collector 22A of the negative electrode 22.

Subsequently, the positive electrode 21 and the negative electrode current collector 22A on which the negative electrode active material layer 22B was formed were laminated on each other with the separator 23 (polyethylene film having a thickness of 12 μm) interposed therebetween, thereby producing a laminate. Subsequently, the laminate was wound to produce a wound body having the space 20S, and then the center pin 24 was inserted into the space 20S.

Subsequently, the insulating plates 12 and 13 were housed in the battery can 11 together with the wound body. In this case, the positive electrode lead 25 was welded to the safety valve mechanism 15, and the negative electrode lead 26 was welded to the battery can 11. Subsequently, the wound body was impregnated with the electrolytic solution by injecting the electrolytic solution into the battery can 11.

Finally, the battery cover 14, the safety valve mechanism 15, and the PTC element 16 were accommodated inside the battery can 11, and then the battery can 11 was crimped with the gasket 17 interposed therebetween.

Therefore, since the wound body was enclosed in the battery can 11, the secondary battery was assembled.

### (Stabilization Treatment of Assembled Secondary Battery)

The assembled secondary battery was charged and discharged for 1 cycle in an ambient temperature environment (temperature=23° C.), and then the secondary battery was left in the same environment (aging time=60 hours). At the time of charging, constant current charging was performed at a current of 0.1 C until the voltage reached 4.2 V, and then constant voltage charging was performed at a voltage of 4.2 V until the current reached 0.05 C. At the time of discharging, constant current discharging was performed at a current of 0.1 C until the voltage reached 2.5 V. 0.1 C refers to a current value at which the battery capacity (theoretical capacity) can be discharged in 10 hours, and 0.05 C refers to a current value at which the battery capacity can be discharged in 20 hours.

As a result, the coating film 22C was formed on the surface of the negative electrode active material layer 22B, thereby producing the negative electrode 22. Therefore, the electrochemically stabilized battery element 20 was produced, and the battery element 20 was enclosed in the battery can 11, so that the secondary battery was completed (Examples 1 to 3 and Comparative Examples 1 to 4).

### [Production of Another Secondary Battery]

For comparison, another secondary battery was produced by the same procedure, except that another copolymer was used instead of the ternary copolymer as the negative electrode binder.

As the other copolymer, a copolymer (AAA) of acrylamide, acrylic acid, and acrylonitrile was used. In this case, the copolymerization amounts of acrylamide, acrylic acid, and acrylonitrile were set to 18.6 wt %, 36.2 wt %, and 45.2 wt %, respectively (Comparative Example 5).

As the other copolymer, a copolymer (AAANa) of acrylamide, sodium acrylate, and acrylonitrile was used. In this case, the copolymerization amounts of acrylamide, sodium acrylate, and acrylonitrile were set to 18.6 wt %, 36.2 wt %, and 45.2 wt %, respectively (Comparative Example 6).

### [Concentration Ratios X1 and X2]

After completion of the secondary battery, the negative electrode 22 was subjected to surface analysis using XPS to calculate each of the concentration ratios X1 and X2, and the results are as shown in Table 1. The analysis procedure of the negative electrode 22 using XPS and the calculation procedure of each of the concentration ratios X1 and X2 are as described above.

In the case of producing the secondary battery, as described above, in the step of producing the negative electrode 22, each of the concentration ratios X1 and X2 was changed by adjusting the mixing ratio of the negative electrode active material, the negative electrode binder, and the negative electrode conductive agent.

### [Evaluation on Battery Characteristics]

The battery characteristics (electrical resistance characteristics, initial charge and discharge characteristics, discharge temperature characteristics, and cycle characteristics) were evaluated by the procedure described below, and the results shown in Table 1 were obtained.

### (Electrical Resistance Characteristics)

The secondary battery was charged in an ambient temperature environment (temperature=23° C.). At the time of charging, constant current charging was performed at a current of 1 C until the voltage reached 3.6 V, and then constant voltage charging was performed at a voltage of 3.6 V until the total charging time reached 10 hours. 1 C refers to a current value at which the battery capacity can be discharged in 1 hour.

Thereafter, the electrical resistance (mΩ), which is an index for evaluating electrical resistance characteristics, was measured using an AC impedance method (frequency=1 kHz).

### (Initial Charge and Discharge Characteristics)

First, the secondary battery was charged in an ambient temperature environment (temperature=23° C.), thereby measuring the charge capacity. Subsequently, the secondary battery was discharged in the same environment to measure the discharge capacity. Finally, the initial efficiency, which is an index for evaluating the initial charge and discharge characteristics, was calculated based on a calculation formula of initial efficiency (%)=(discharge capacity/charge capacity)×100.

At the time of charging, constant current charging was performed at a current of 0.2 C until the voltage reached 4.2 V, and then constant voltage charging was performed at a voltage of 4.2 V until the total charging time reached 10 hours. At the time of discharging, constant current discharging was performed at a current of 0.2 C until the voltage reached 2.0 V. 0.2 C refers to a current value at which the battery capacity can be discharged in 5 hours.

### (Discharge Temperature Characteristics)

First, the secondary battery was charged in an ambient temperature environment (temperature=23° C.). At the time of charging, constant current charging was performed at a current of 1 C until the voltage reached 4.2 V, and then constant voltage charging was performed at a voltage of 4.2 V until the total charging time reached 2.5 hours.

Subsequently, six kinds of discharge capacities were measured by discharging the secondary battery in each of six kinds of environments (temperature=−20° C., −10° C., 0° C., 23° C., 45° C., and 60° C.). At the time of discharging, constant current discharging was performed at a current of 2.5 C until the voltage reached 2.5 V. 2.5 C refers to a current value at which the battery capacity can be discharged in 0.4 hours.

As a result, six kinds of discharge capacities were obtained in each of Examples 1 to 3 and Comparative Examples 1 to 6.

Subsequently, a subtraction process of subtracting the six kinds of discharge capacities obtained in Comparative Example 6 from the six kinds of discharge capacities obtained in Example 1 was performed to obtain six kinds of discharge capacities after the subtraction process.

In this case, six types of subtraction processes described below were performed by performing the subtraction process for each of the six kinds of temperatures (=−20° C., −10° C., 0° C., 23° C., 45° C., and 60° C.) described above. First, the subtraction process was performed using a calculation formula of discharge capacity of Example 1 (temperature=−20° C.)−discharge capacity of Comparative Example 6 (temperature=−20° C.). Second, the subtraction process was performed using a calculation formula of discharge capacity of Example 1 (temperature=−10° C.)−discharge capacity of Comparative Example 6 (temperature=−10° C.). Third, the subtraction process was performed using a calculation formula of discharge capacity of Example 1 (temperature=0° C.)−discharge capacity of Comparative Example 6 (temperature=0° C.). Fourth, the subtraction process was performed using a calculation formula of discharge capacity of Example 1 (temperature=23° C.)−discharge capacity of Comparative Example 6 (temperature=23° C.). Fifth, the subtraction process was performed using a calculation formula of discharge capacity of Example 1 (temperature=45° C.)−discharge capacity of Comparative Example 6 (temperature=45° C.). Sixth, the subtraction process was performed using a calculation formula of discharge capacity of Example 1 (temperature=60° C.)−discharge capacity of Comparative Example 6 (temperature=60° C.).

Subsequently, the ratios of the discharge capacities after the subtraction process to the six kinds of discharge capacities obtained in Comparative Example 6 were calculated, thereby obtaining six kinds of improvement rates (%).

In this case, six types of improvement rate calculation processes described below were performed by performing the ratio calculation process for each of the six kinds of temperatures (=−20° C., −10° ° C., 0° C., 23° C., 45° C., and 60° C.) described above. Specifically, first, the improvement rate was calculated using a calculation formula of improvement rate=[discharge capacity after subtraction process (temperature=−20° C.)/discharge capacity of Comparative Example 6 (temperature=−20° C.)]×100. Second, the improvement rate was calculated using a calculation formula of improvement rate=[discharge capacity after subtraction process (temperature=−10° C.)/discharge capacity of Comparative Example 6 (temperature=−10° C.)]×100. Third, the improvement rate was calculated using a calculation formula of improvement rate=[discharge capacity after subtraction process (temperature=0° C.)/discharge capacity of Comparative Example 6 (temperature=0° C.)]×100. Fourth, the improvement rate was calculated using a calculation formula of improvement rate=[discharge capacity after subtraction process (temperature=23° C.)/discharge capacity of Comparative Example 6 (temperature=23° C.)]×100. Fifth, the improvement rate was calculated using a calculation formula of improvement rate=[discharge capacity after subtraction process (temperature=45° C.)/discharge capacity of Comparative Example 6 (temperature=45° C.)]×100. Sixth, the improvement rate was calculated using a calculation formula of improvement rate=[discharge capacity after subtraction process (temperature=60° C.)/discharge capacity of Comparative Example 6 (temperature=60° C.)]×100.

Subsequently, an average value of six kinds of improvement rates was calculated to calculate an average improvement rate (%) as an index for evaluating discharge temperature characteristics.

Finally, the average improvement rate was calculated for each of Examples 2 and 3 and Comparative Examples 1 to 5 by the same procedure as in the case of calculating the average improvement rate for Example 1.

### (Cycle Characteristics)

First, the secondary battery was charged and discharged in an ambient temperature environment (temperature=23° C.), thereby measuring the discharge capacity (discharge capacity at the first cycle). Subsequently, the secondary battery was repeatedly charged and discharged in the same environment until the total number of cycles reached 650 cycles to measure the discharge capacity (discharge capacity at the 650th cycle). Finally, the capacity retention rate, which is an index for evaluating cycle characteristics, was calculated based on a calculation formula of capacity retention rate (%)=(discharge capacity at the 650th cycle/discharge capacity at the first cycle)×100. The charge and discharge conditions are the same as the charge and discharge conditions when the initial charge and discharge characteristics are evaluated.

TABLE 1

| | Negative | | | | | | | |
|---|---|---|---|---|---|---|---|---|
| | electrode binder | | Concentration | Concentration | Electrical | Initial | Average | Capacity |
| | Ternary | Other | ratio | ratio | resistance | efficiency | improvement | retention |
| | copolymer | copolymer | X1 | X2 | (mΩ) | (%) | rate (%) | rate (%) |
| Example 1 | AAALi | — | 0.4 | 3.4 | 58.8 | 88.9 | 3.1 | 53.6 |
| Example 2 | AAALi | — | 1.5 | 4.6 | 59.1 | 88.9 | 3.1 | 53.6 |
| Example 3 | AAALi | — | 2.7 | 5.9 | 58.5 | 88.8 | 3.2 | 53.5 |
| Comparative | AAALi | — | 3.1 | 6.5 | 62.4 | 87.5 | 2.9 | 52.8 |
| Example 1 | | | | | | | | |
| Comparative | AAALi | — | 3.5 | 7.0 | 68.2 | 82.0 | 1.7 | 49.6 |
| Example 2 | | | | | | | | |
| Comparative | AAALi | — | 4.0 | 7.4 | 76.3 | 65.0 | <0 | 45.5 |
| Example 3 | | | | | | | | |
| Comparative | AAALi | — | 0.2 | 4.6 | 72.0 | 76.8 | <0 | 33.7 |
| Example 4 | | | | | | | | |
| Comparative | — | AAA | 2.9 | 5.9 | 69.0 | 87.6 | 2.6 | 51.5 |
| Example 5 | | | | | | | | |
| Comparative | — | AAANa | 2.7 | 6.1 | 61.0 | 86.8 | 1.0 | 52.3 |
| Example 6 | | | | | | | | |

As shown in Table 1, each of the electrical resistance, the initial efficiency, the average improvement rate, and the capacity retention rate greatly varied depending on the configuration of the secondary battery.

Specifically, when the negative electrode binder did not contain the ternary copolymer but contained another copolymer (Comparative Examples 5 and 6), the electrical resistance increased and each of the initial efficiency, the average improvement rate, and the capacity retention rate decreased regardless of whether the physical property conditions 1 and 2 (concentration ratio X1=0.4 to 2.7 and concentration ratio X2=3.4 to 5.9) were satisfied.

On the other hand, when the negative electrode binder contained the ternary copolymer (Examples 1 to 3 and Comparative Examples 1 to 4), each of the electrical resistance, the initial efficiency, the average improvement rate, and the capacity retention rate varied depending on whether or not the physical property conditions 1 and 2 were satisfied.

Specifically, when the physical property conditions 1 and 2 were not satisfied (Comparative Examples 1 to 4), the electrical resistance increased, and each of the initial efficiency, the average improvement rate, and the capacity retention rate decreased.

However, when the physical property conditions 1 and 2 were satisfied (Examples 1 to 3), the electrical resistance decreased, and each of the initial efficiency, the average improvement rate, and the capacity retention rate increased.

In particular, in a case where the physical property conditions 1 and 2 were satisfied, when the negative electrode active material layer 22B contained the negative electrode conductive agent (carbon material), the electrical resistance was sufficiently reduced, and each of the initial efficiency, the average improvement rate, and the capacity retention rate was sufficiently increased.

From the results shown in Table 1, when the negative electrode 22 included the negative electrode active material layer 22B and the coating film 22C, the negative electrode active material layer 22B contained the negative electrode binder (ternary copolymer), and in surface analysis of the negative electrode 22 using XPS, the concentration ratio X1 was 0.4 to 2.7 and the concentration ratio X2 was 3.4 to 5.9, each of the initial efficiency, the average improvement rate, and the capacity retention rate increased while the electrical resistance decreased. Therefore, since electrical resistance characteristics, initial charge and discharge characteristics, discharge temperature characteristics, and cycle characteristics each were improved, excellent battery characteristics could be obtained in the secondary battery.

Although the present technology has been described above with reference to the embodiment and the examples, the configurations of the present technology are not limited to the configurations described in the embodiment and the examples, and are therefore modifiable in a variety of ways.

Specifically, a case where the battery structure of the secondary battery is cylindrical has been described. However, the battery structure of the secondary battery is not particularly limited, and thus may be a laminate film type, a square type, a coin type, a button type, and the like.

A case where the electrode reactant is lithium has been described, but the electrode reactant is not particularly limited. Specifically, as described above, the electrode reactant may be other alkali metals such as sodium and potassium, or alkaline earth metals such as beryllium, magnesium, and calcium. In addition, the electrode reactant may be another light metal such as aluminum.

Since the effects described in the present specification are merely examples, the effects of the present technology are not limited to the effects described in the present specification. Therefore, other effects regarding the present technology may be obtained.

The present technology may also take the following configurations according to an embodiment.

<1>

A secondary battery including:
a positive electrode;
a negative electrode; and
an electrolytic solution,
in which the negative electrode includes:
   a negative electrode active material layer containing a negative electrode binder; and
   a coating film provided on a surface of the negative electrode active material layer,
the negative electrode binder contains a copolymer of acrylamide, lithium acrylate, and acrylonitrile,
a C1s spectrum, an Nis spectrum, and an Li1s spectrum are detected by surface analysis of the negative electrode using X-ray photoelectron spectroscopy,
a first concentration ratio as calculated by Equation (1) is 0.4 or more and 2.7 or less, and
a second concentration ratio as calculated by Equation (2) is 3.4 or more and 5.9 or less,

$$X 1 = XC / XN \qquad ( 1 )$$

where X1 is the first concentration ratio, XC is an atomic concentration (atom %) of carbon as calculated based on the C1s spectrum, and XN is an atomic concentration (atom %) of nitrogen as calculated based on the Nis spectrum,

$$X 2 = XL / XN \qquad ( 2 )$$

where X2 is the second concentration ratio, XL is an atomic concentration (atom %) of lithium as calculated based on the Li1s spectrum, and XN is an atomic concentration (atom %) of nitrogen as calculated based on the Ns spectrum.
   <2>

The secondary battery according to <1>, in which
the negative electrode active material layer further contains a negative electrode conductive agent, and
the negative electrode conductive agent contains a carbon material.
   <3>

The secondary battery according to <1> or <2>, which is a lithium ion secondary battery.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A secondary battery comprising:
a positive electrode;
a negative electrode; and
an electrolytic solution,
wherein the negative electrode includes:
a negative electrode active material layer including a negative electrode binder; and
a coating film provided on a surface of the negative electrode active material layer,
the negative electrode binder includes a copolymer of acrylamide, lithium acrylate, and acrylonitrile,
a C1s spectrum, an N1s spectrum, and an Li1s spectrum are detected by surface analysis of the negative electrode using X-ray photoelectron spectroscopy,
a first concentration ratio as calculated by Equation (1) is 0.4 or more and 2.7 or less, and
a second concentration ratio as calculated by Equation (2) is 3.4 or more and 5.9 or less,
$$X 1 = XC / XN \qquad ( 1 )$$
where X1 is the first concentration ratio, XC is an atomic concentration (atom %) of carbon as calculated based on the C1s spectrum, and XN is an atomic concentration (atom %) of nitrogen as calculated based on the N1s spectrum,
$$X 2 = XL / XN \qquad ( 2 )$$
where X2 is the second concentration ratio, XL is an atomic concentration (atom %) of lithium as calculated based on the Li1s spectrum, and XN is an atomic concentration (atom %) of nitrogen as calculated based on the N1s spectrum.

2. The secondary battery according to claim 1, wherein the negative electrode active material layer further includes a negative electrode conductive agent, and
the negative electrode conductive agent includes a carbon material.

3. The secondary battery according to claim 1, which is a lithium ion secondary battery.
